(19) United States
(12) Patent Application Publication
(10) Pub. No.: US 2006/0277273 A1
(43) Pub. Date: Dec. 7, 2006

(54) Online travel system

(76) Inventor: William L. Hawkins, White Sulphur Springs, WV (US)

Correspondence Address: Royal W. Craig;OBER|KALER, 120 East Baltimore Street, Baltimore, MD, 21202-1643, US

(21) Appl. No.: 11/447,651

(22) Filed: Jun. 6, 2006

Related U.S. Application Data
(60) Provisional application No. 60/688,293, filed on Jun. 7, 2005.

(51) Int. Cl. G06F 15/16

(52) U.S. Cl. 709/217

(57) ABSTRACT

A unified web portal for potential travelers to find localized information specific to a particular geographic area and assist in direct booking of an itinerary with the selected establishments. The website is implemented on a web-enabled server maintained by a Manager, and includes a home page containing introductory travel information on the localized area and URL links to Business, Tourism, Lodging and Restaurants pages allowing the Client to specify travel categories for submission to a search engine to compile “best match” third-party URL links based on the categories, as we well as a Contact Us page displaying Manager contact info, an Upcoming Events page display a list of upcoming local events in the area. The layout of the web portal provides easy access to localized information specific to a particular geographic area, offers specific answers to questions that they might have, and provides a search engine that facilitates compilation of a personalized itinerary displayed with arrangements for direct booking through the respective establishments.

### CROSS-REFERENCE TO RELATED APPLICATIONS

The present application derives priority from U.S. provisional application No. 60/688,293 filed Jun. 6, 2005.

### BACKGROUND OF THE INVENTION

1. Field of the Invention

The present invention relates to online travel portals and, more specifically, to a unified web-implemented travel information, assistance and booking consolidation system specifically adapted for local geographical areas.

2. Description of the Background

According to surveys, four in five U.S. adults will take at least one trip for leisure within the next six months, and one in five will travel for business purposes. The most common way to book this travel is by online travel websites (28% of leisure travelers and 31% of business/leisure travelers use them). This indicates that travelers perceive significant value in these sites. Nearly two in five adults believe online travel agencies offer the lowest prices, and nearly a third believe that these online agencies offer the best value.

For those who have booked or plan to book travel arrangements using online travel agencies, Travelocity, Orbitz and Expedia are the dominant agencies. However, users also credit website design and ease of use as being important aspects, along with the quality of vacation packages offered, and the ability to speak to a live agent as top influences. If travel websites in general are looking to increase customer loyalty, they need to focus on three areas—price, information and service.

None of the conventional websites offer neutral price offerings, nor do they provide localized information specific to a particular area, nor consolidated search capabilities to find the most suitable accommodations in that area.

It would be greatly advantageous to provide a web-based software solution that gives a single point of entry for a potential traveler to find localized information specific to a particular geographic area, seek specific answers to questions that they might have, and find a travel booking agent that offers their desired arrangements for direct booking through that agent. The system is implemented on one or more web-enabled servers maintained by a Manager.

### SUMMARY OF THE INVENTION

It is therefore an object of the present invention to provide a website point of entry for a potential traveler to search localized information specific to a particular geographic area, seek specific answers to questions that they might have, compile a custom itinerary, and allow them to book travel amenities directly with the establishments.

It is another object to implement the above-described system via a web enabled server maintained by a Manager to facilitate interaction and provide information to potential traveler “Clients.”

In accordance with the foregoing objects, the present invention is a unified web portal for potential travelers to search localized information specific to a particular geographic area and plan an itinerary. The website is implemented on a web-enabled server maintained by a Manager to facilitate participation by potential traveler Clients. The website includes a home page containing introductory travel information on the localized area and URL links to the following pages:

A Businesses page including alternate search forms including a keyword search or a specific search for allowing the Client to specify businesses and resource categories that they are interested in, as well as city and regional location, and an activation button to send the highlights and resources of interest to a search engine to compile search results sorted by “best match” based on the categories;

A Tourism page including alternate search forms including a keyword search or a specific search for allowing the Client to specify tourist attractions and resource categories that they are interested in, as well as city and regional location, and an activation button to send the highlights and resources of interest to a search engine to compile search results sorted by “best match” based on the categories;

a Lodging Page comprising alternate search forms including a keyword search or a specific search for allowing the Client to specify Lodging characteristics that they seek, as well as particular cities or regions for which they desire lodging accommodations, and a desired price rate category for the accommodations, and a link to send the highlights and resources of interest to a search engine to compile search results sorted by “best match” based on the specifications;

a Contact Us page displaying Manager contact info, and an online request form for allowing the Client to specify their travel interests, request a newsletter, and submit a request directly to the Manager for answering; and

an Upcoming Events page display a list of upcoming local events in an area and to allow the Client to register to receive promotional emails about the events.

By navigating the Businesses, Tourism, Lodging and Restaurants pages, the Client can search and select entries from among the search results and compile an itinerary there from. The number of items in the itinerary is tracked and displayed and the Client can view their itinerary at any time while they remain on the site, thereby calling up a detailed display for each itinerary item with contact information, phone and direct email link so that Clients can book their itinerary directly through booking agents associated with each item.

The web portal of the present invention aids a potential traveler in searching localized information specific to a particular geographic area, offers specific answers to questions that they might have, and provides a consolidated booking search engine that offers their desired arrangements for direct booking through that agent. This coordinates the efforts of booking agents “Vendors” and potential traveler “Clients”, and provides more value at a considerable savings of time and effort.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a block diagram illustrating the basic layout of the present website.

FIG. 2 is a screen print of the home page, which includes links to other pages: Businesses, Tourism, Lodging, Restaurants, Events, Contact Us.

FIGS. 3 and 4 collectively comprise a screen print of the Businesses page.

FIG. 5 is a screen print of the Upcoming Events page.

FIG. 6 is a screen print of an exemplary detailed display for The Book Exchange,

### DETAILED DESCRIPTION OF THE PREFERRED EMBODIMENTS

The present invention is a method embodied in a website point of entry for a potential traveler to search for localized information specific to a particular geographic area, seek specific answers to questions that they might have, and find a travel booking agent that offers their desired arrangements for direct booking through that agent. The website may, for instance, focus on the geographical area of West Virginia and accordingly be reached at an appropriately named URL such as, for example, WVYourWay.com.

The website is preferably implemented on one or more independent web-enabled server maintained by a Manager (or application service provider ‘ASP’), thereby brokering communications between travel booking agents or “Vendors” and potential traveler “Clients”. The back-end web-enabled servers are maintained at the Manager site and communicate over the Internet. The back-end Manager server(s) may run on a web-enabled Microsoft platform, such as Windows 2000 Advanced Server edition and MS SQL Server 2000, though these are exemplary components only and other web-enabled platform will suffice. Data extracted from the website (to be described) populates an SQL (or other suitable) database with the information. The site is specifically adapted to allow a potential traveler or “Client” to use any remote computer equipped with a conventional web browser to log on to the Internet and access the website maintained on the Manager web server. The database is pre-populated with various business biographical information classified by type of business (lodging, restaurants, doctors, lawyers or a host of other services or professions). The potential traveler can easily search the businesses and amenities they will need for an upcoming trip, gather details, make selections, and compile an itinerary. It is possible to search multiple unrelated categories simultaneously by a region of the state and/or the entire state. This allows the potential traveler to find exactly what they are looking for and find it fast. The present website differs from most existing travel-related sites because it does not facilitate booking of the itinerary through a consolidated reservation service. Instead, it allows the potential traveler to complete their own itinerary including contact information for the selected businesses, lodging, restaurants, doctors, lawyers, etc., and directions, thereby allowing the traveler to book his own reservations. Revenue is collected in the form of a reasonable advertising fee as opposed to a commission, and this makes it a much more attractive marketing venue for smaller localized businesses that lack the resources to list on major national travel sites.

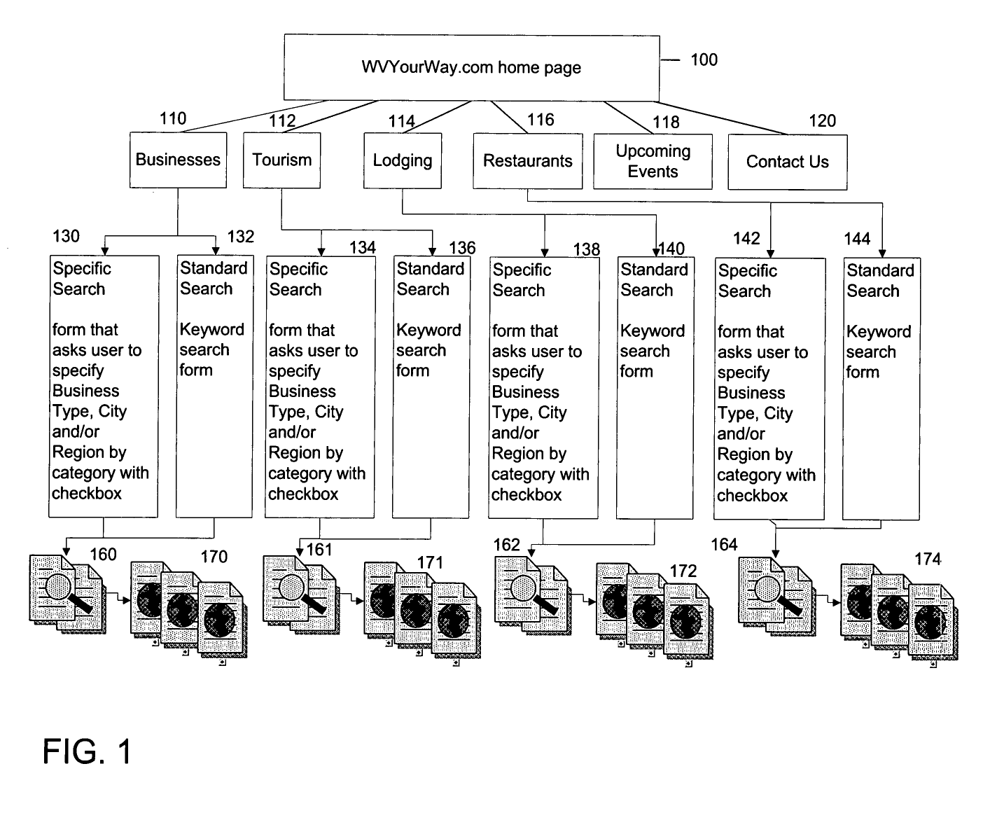

FIG. 1 is a block diagram illustrating the basic layout of the present website, which is herein described in detail from the perspective of a Client.

At step 100, the Client accesses the home URL such as www.WVYourWay.com with their browser. This engenders a home page that contains introductory and travel information on a specific localized area (here, for example, West Virginia), advocating the use of the website to search resources without having to search all over the web. The user may plan for vacations, whether for extended travel, or even one day trips. They do not search for a vacation package that fits their interest as in conventional travel sites, but instead create their own package piece-by-piece, based on what they want, resulting in an itinerary complete with contact information and directions.

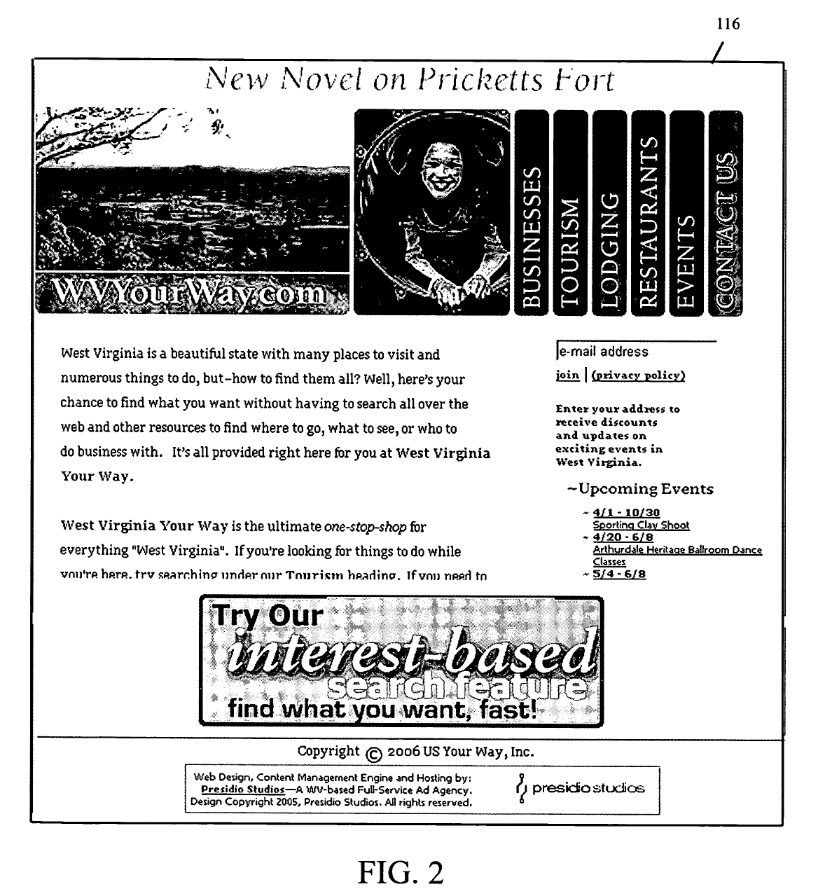

FIG. 2 is a screen print of the home page, which includes index-folder links (top) to the following other pages: Businesses, Tourism, Lodging, Restaurants, Events, and Contact Us (note that a capsule of the Event information may be shown directly on the home page as in FIG. 2, right column).

Referring back to FIG. 1, at step 110 if the Client presses the Businesses Link he/she is taken to a Businesses page that includes alternate search forms (steps 130, 132) by which the Client specifies what business-related travel highlights or resources they are interested in.

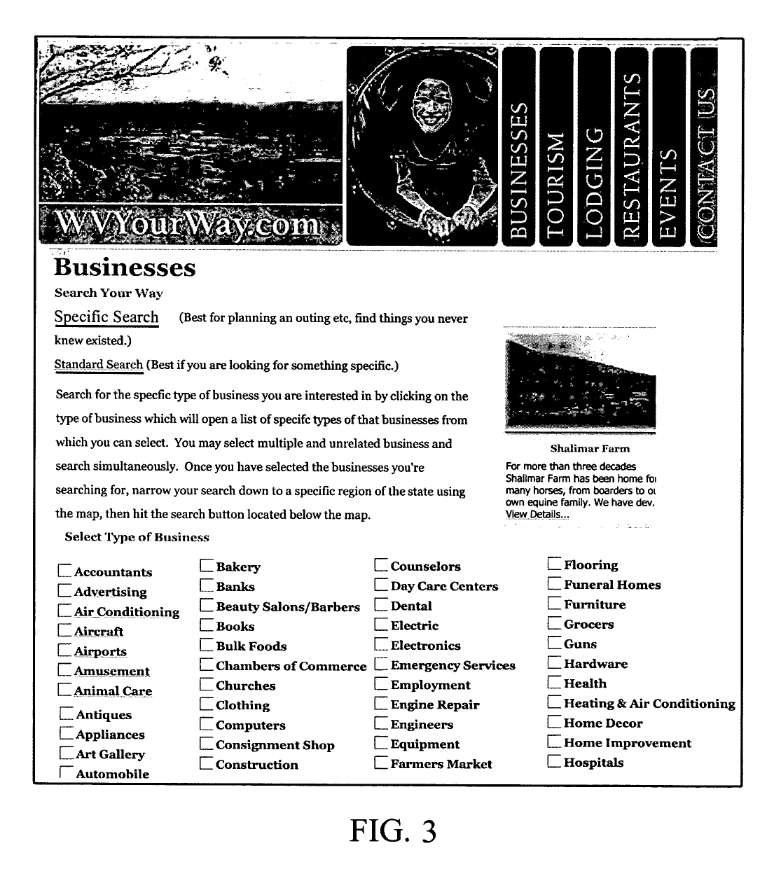

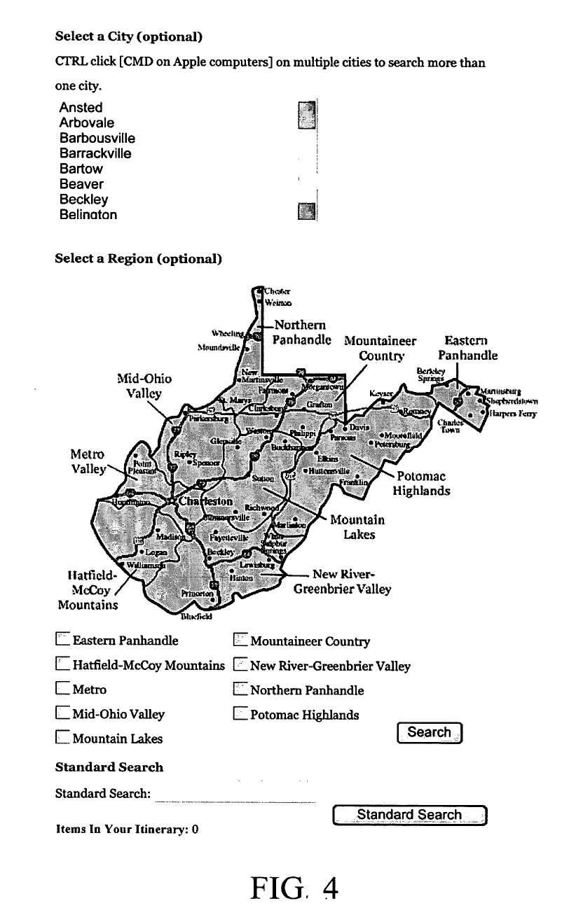

FIGS. 3 and 4 collectively comprise a screen print of the Businesses page. The Client is initially presented with link options (top of FIG. 3) of conducting a Specific Search (indicated as best for planning an outing etc, or anything not already known to exist), or a Standard (keyword) Search (best if looking for something specific). Clicking on the Standard (keyword) Search will direct the Client to the bottom of the page (see bottom of FIG. 4) where a keyword search form may be completed and submitted. Clicking on the Specific Search link (or scrolling downward) takes the client into a multi-faceted search form including optional search fields for Type of Business, City, and Region. The Select Type of Business heading invites the Client to select from a wide variety of business resources listed categorically proximate checkboxes, so that the Client need only check their interests. A full categorical index of businesses is provided, with sub-indices, including for example, Accountants (Bookkeeping Service, Certified Public, Corporation, Tax Services); Advertising (Advertising Agency, Embroidery/Screen printing, Outdoor Signs); Air Conditioning (All Air Conditioning); Aircraft (Charter, Rental); Airports (All Airports); Amusement (Equipment, Parks, Places); Animal Care (All Animal Care, Animal Hospital, Animal Shelters, Humane Society, Kennels, Pet Stores, Pet Supplies, Veterinarians); Antiques (All Antiques, Antique Retail); Appliances (Dealers, Rentals, Repair); Art Gallery (All Art Gallery, Art Classes, Art Works, Custom Framing); Automobile (Auto Detailing, Body & Paint, Car Audio, Car Wash & Polish-Services, Drive shafts, Glass, Import Car Specialists, Interior Auto Detailing, Leasing, New Car Dealers, Parts & Supplies, Renting, Repair & Service, Salvage Yard, Tires, Towing & Wrecker Services, Truck Accessories, Used Car Dealers, Wheels); etc. It should be apparent that the categorical index with sub-indices of businesses is very thorough. One skilled in the art will understand that these are exemplary categories and the present invention should not be considered as limited to specific categories. The Client may select one or more categories by checking the associated check box.

Moving downward (to the top of FIG. 4), the Select City heading invites the Client to select the City within which the business resources reside. The City selection is presented in the form of a scroll window with all available cities listed, and the Client may select none, any one, or may CTRL click and drag across multiple cities to search more than one city.

Moving downward (bottom of FIG. 4), the Select Region heading invites the Client to select the geographical region within which the business resources reside. The Region selection is presented in the form of a Map with all available cities indicated by legends, and the Client may select none, any one, or multiple regions by clicking on the Map. The Regions are also listed in text beneath the map proximate check boxes. The listed regions may include checkboxes for any one from among the following group:

Eastern Panhandle Mountaineer Country

Hatfield-McCoy Mountains New River-Greenbrier Valley

Metro Northern Panhandle

Mid-Ohio Valley Potomac Highlands

Mountain Lakes

As the user clicks on the Map the appropriate check box there beneath is checked off. Alternately, the Client may simply check the corresponding check boxes directly.

Any one, or a subcombination of the interests for Type of Business, City, and Region may be checked (or none at all) in the multi-faceted search form. Once all desired interests are checked (Type of Business, City, Region), the Client clicks on the Search button to the right. Referring back to FIG. 1, at step 160 clicking “Search” submits the categories associated with each interest to a search engine, and at step 170 the Client is presented with the search results sorted by “best match” based on the number of categories that match interests (equal rankings are listed alphabetically). A conventional licensed web-search engine is used for this purpose. The search results include links to each matching site, and those sites can be accessed directly.

Referring back to FIG. 1, at step 112 the Client may press the Tourism Link, in which case he/she is taken to a Tourism page that, as above, includes alternate search forms (steps 134, 136) by which the Client specifies what tourism-related travel highlights or resources they are interested in. Again the Client is initially presented with link options of conducting a Specific Search (indicated as best for anything not already known to exist), or a Standard (keyword) Search (best if looking for something specific). Clicking on the Standard (keyword) Search will direct the Client to a keyword search form that may be completed and submitted. Clicking on the Specific Search link (or scrolling downward) takes the client into a multi-faceted search form including optional search fields for Tourism Interests, City and region. The Select Tourism Interests invites the Client to select from a wide variety of tourism interests listed categorically proximate checkboxes, so that the Client need only check their interests. A full categorical index of tourism interests is provided, with sub-indices as necessary, including for example, Antiques, Art, Arts & Crafts, ATV Trails, Auctions, Ballooning, Biking, Bird Watching, Boating, Books Candles, Canoeing, Carriage Rides, Caves, Cemetery, etc. It should be apparent that the categorical index with sub-indices of tourism interests is thorough. One skilled in the art will understand that these are exemplary categories and the present invention should not be considered as limited to specific categories. The Client may select one or more categories by checking the associated check box.

As above, a Select City form is also provided and this invites the Client to select the City within which the tourism interests reside. The City selection is presented in the form of a scroll window with all available cities listed, and the Client may select none, any one, or may CTRL click and drag across multiple cities to search more than one city. Also, a like Select Region form is provided and this invites the Client to select the geographical region within which the tourism interests reside. The Region selection is presented in the form of a Map with all available cities indicated by legends, and the Client may select none, any one or multiple regions by clicking on the Map. The Regions are also listed in text beneath the map proximate check boxes. The listed regions may include checkboxes for any one from among the above-described group (Eastern Panhandle Mountaineer Country, etc.). Any one, or a subcombination of the Tourism Interests, City and region may be checked (or none at all) in the multi-faceted search form. Once all desired tourism interests are checked (Type of Tourism Interest, City, Region), the Client clicks on the Search button to the right. Referring back to FIG. 1, at step 128 clicking “Search” submits the categories associated with each interest to a search engine, and at step 132 the Client is presented with the search results sorted by “best match” based on the number of categories that match interests (equal rankings are listed alphabetically). In other words, the results are sorted in accordance with the number of checked categories that apply to a given attraction, the more checks that apply the higher that attraction will appear on the results page. In addition, attractions that are listed as “lodging” may cater to a checked tourism interest or may be close by. This allows the Client to find an interest and lodging at the same time. A conventional licensed web-search engine is used for this searching purpose. The search results include links to each matching site, and those sites can be accessed directly.

Referring back to FIG. 1, at step 114 the Client may press the Lodging Link, in which case he/she is taken to a Lodging page that includes a search form that asks the Client to specify Lodging details they are interested in. The Lodging Page, as above, includes alternate search forms (steps 138, 140) by which the Client specifies what lodging features they are interested in. Again the Client is initially presented with link options of conducting a Specific Search (indicated as best for anything not already known to exist), or a Standard (keyword) Search (best if looking for something specific). Clicking on the Standard (keyword) Search will direct the Client to a keyword search form that may be completed and submitted. Clicking on the Specific Search link (or scrolling downward) takes the client into a multi-faceted search form including optional search fields for Lodging Interests, City and Region, and Average cost. The Select Lodging Interests invites the Client to select from a wide variety of lodging amenities listed categorically proximate checkboxes, so that the Client need only check their interests. A full categorical index of lodging interests is provided, with sub-indices as necessary, including for example, Bed & Breakfast, Cabins, Caboose, Camping—RVs tents, Coffee in Room, Conference Center, Continental Breakfast, Cottages, Efficiencies, Extended Stay, Fitness Room, High Speed Internet Access, Hot Tub/Spa, Hotels, Indoor Pool, Inn, Jacuzzi, Jacuzzi Rooms, Kitchenettes, Lodges, Lodging Coordinators, Meeting Rooms, Motels, Resorts, Rooms, Suites, Vacation Home Rental, Wireless Internet, etc. It should be apparent that the categorical index of Lodging amenities is thorough. One skilled in the art will understand that these are exemplary categories and the present invention should not be considered as limited to specific categories. The Client may select one or more categories by checking the associated check box.

As above, a Select City form is also provided and this invites the Client to select the City within which the tourism interests reside. The City selection is presented in the form of a scroll window with all available cities listed, and the Client may select none, any one, or may CTRL click and drag across multiple cities to search more than one city. Also, a like Select Region form is provided and this invites the Client to select the geographical region within which the tourism interests reside. The Region selection is presented in the form of a Map with all available cities indicated by legends, and the Client may select none, any one, or multiple regions by clicking on the Map. The Regions are also listed in text beneath the map proximate check boxes. The listed regions may include checkboxes for any one from among the above-described group (Eastern Panhandle Mountaineer Country, etc.).

In addition to the foregoing, an optional Select Average cost per family (based on a family of four) selection is provided comprising a Minimum window and Maximum window, both of which may be filled in as desired.

Any one, or a subcombination of the Amenities, City, Region and/or Select Average cost may be checked (or none at all) in the multi-faceted search form. Once all desired Lodging interests are checked (Amenities, City, Region, Average cost), the Client clicks on the Search button to the right. Referring back to FIG. 1, at step 162 clicking “Search” submits the categories associated with each interest to a search engine, and at step 172 the Client is presented with the search results sorted by “best match” based on the number of categories that match interests (equal rankings are listed alphabetically). In other words, the results are sorted in accordance with the number of checked categories that apply to a given attraction, the more checks that apply the higher that attraction will appear on the results page. In addition, attractions that are listed as “lodging” may cater to a checked tourism interest or may be close by. This allows the Client to find an interest and lodging at the same time. A conventional licensed web-search engine is used for this searching purpose. The search results include links to each matching site, and those sites can be accessed directly.

Referring back to FIG. 1, at step 116 the Client may press the Restaurants Link, in which case he/she is taken to a Restaurants page that includes a search form that asks the Client to specify Restaurant details they are interested in. The Restaurants Page, as above, includes alternate search forms (steps 142, 144) by which the Client specifies what Restaurant characteristics they are interested in. The Client is again initially presented with link options of conducting a Specific Search (indicated as best for anything not already known to exist), or a Standard (keyword) Search (best if looking for something specific). Clicking on the Standard (keyword) Search will direct the Client to a keyword search form that may be completed and submitted. Clicking on the Specific Search link (or scrolling downward) takes the client into a multi-faceted search form including optional search fields for Restaurant Types, City, Region and Average Cost. The Select Lodging Interests invites the Client to select from a wide variety of restaurants listed categorically proximate checkboxes, so that the Client need only check their interests. A full categorical index of lodging interests is provided, with sub-indices as necessary, including for example, Asian, Banquet Facilities, Bar-B-Que, Bistro, Breakfast, Buffet, Burgers, Café, Catering, Chinese, Coffee, Continental, Country Cooking, Diner, Dinner Theater, Drive-In, Family, Fastfood, Fine Dining, Food Court, Gourmet Dining, Home-Style Cooking, Hot Dogs, Ice Cream, Indian, Italian, Mexican, Pizza, Sandwiches, Seafood, Steakhouse, Sub Shops, Take Out, TexMex, Wireless Internet, etc. It should be apparent that the categorical index of Restaurants and features is thorough. One skilled in the art will understand that these are exemplary categories and the present invention should not be considered as limited to specific categories. The Client may select one or more categories by checking the associated check box.

As above, a Select City form is also provided and this invites the Client to select the City within which the tourism interests reside. The City selection is presented in the form of a scroll window with all available cities listed, and the Client may select none, any one, or may CTRL click and drag across multiple cities to search more than one city. Also, a like Select Region form is provided and this invites the Client to select the geographical region within which the tourism interests reside. The Region selection is presented in the form of a Map with all available cities indicated by legends, and the Client may select none, any one, or multiple regions by clicking on the Map. The Regions are also listed in text beneath the map proximate check boxes. The listed regions may include checkboxes for any one from among the above-described group (Eastern Panhandle Mountaineer Country, etc.).

In addition to the foregoing, an optional Select Average cost per family (based on a family of four) selection is provided comprising a Minimum window and Maximum window, both of which may be filled in as desired.

Any one, or a subcombination of the Restaurant Interests, inclusive of Amenities, City, Region, Average cost may be checked (or none at all) in the multi-faceted search form. Once all desired Restaurant interests are checked (Amenities, City, Region, Average cost), the Client clicks on the Search button to the right. Referring back to FIG. 1, at step 164 clicking “Search” submits the categories associated with each interest to a search engine, and at step 174 the Client is presented with the search results sorted by “best match” based on the number of categories that match interests (equal rankings are listed alphabetically). A conventional licensed web-search engine is used for this searching purpose. The search results include links to each matching site, and those sites can be accessed directly.

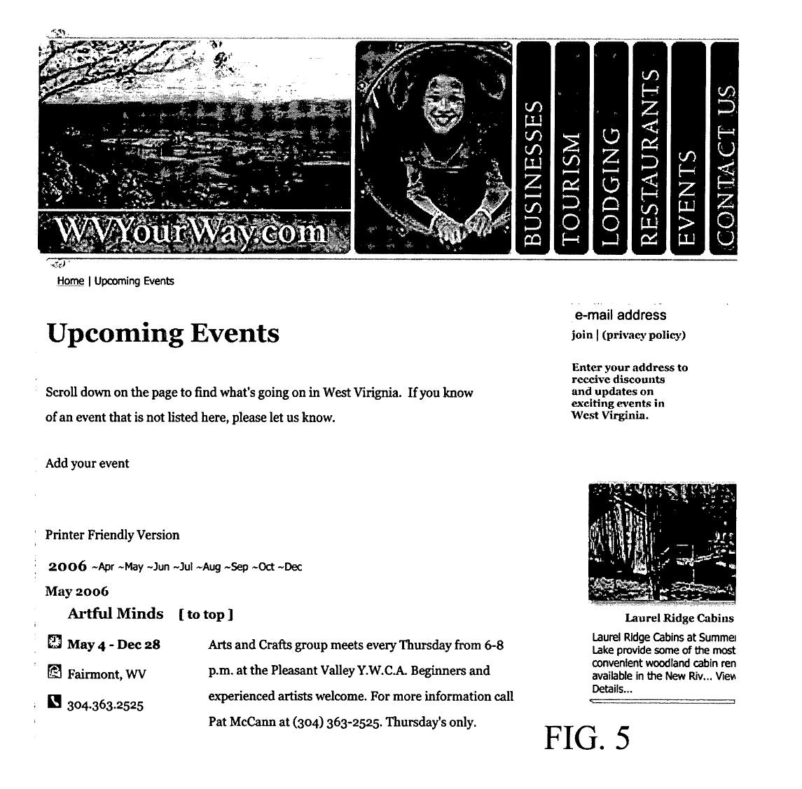

Referring back to FIG. 1, the Upcoming Events link at step 118 will display a list of upcoming local events in the geographic region covered by the website, thereby allowing the Client to sign up to receive promotional emails about the events. FIG. 5 is a screen print of the Upcoming Events page. The Add Your Event link at top display a form by which business and organizations can submit their events for inclusion in the site. Once a submission form is posted the form results are posted in the site database for review and to be followed up on by the staff.

The Contact Us link may be pressed at step 120 to display a page containing Manager contact info, as well as an online request form that allows the Client to specify their interest categories and submit a request directly to the Manager for manual (email) answering. The Client may also sign up for a newsletter on the Contact Us page as well.

All of the above-described Specific Search forms associated with the Businesses, Tourism, Lodging and Restaurants pages are used to compile an SQL database query when the Search Button is clicked, an important advantage being that the same search engine is used for all of the respective searches. After clicking “Search” the Client is presented with the search results sorted by “best match” based on the number of categories that match interests (equal rankings are listed alphabetically). By clicking any item in the search results a Detailed Display is provided.

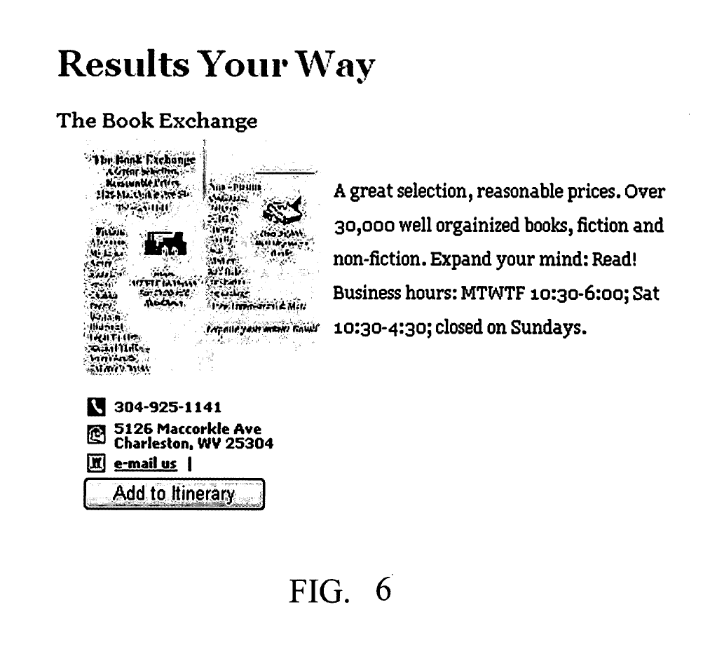

FIG. 6 is a screen print of an exemplary detailed display for The Book Exchange, which includes a capsule summary of the item “A great selection, reasonable prices”, business hours, contact information, and direct email link, and an “Add to Itinerary” Button. By clicking the Add to Itinerary button this particular item will be added to the Clients itinerary. An itinerary is maintained for each client while they remain on the site, and they are free to add as many items as they wish. The number of items in the itinerary is tracked and displayed at the bottom of all pages as seen in FIG. 4, and the Client can view their itinerary by clicking that link. This engenders the complete itinerary inclusive of a detailed display for each added item (e.g., The Book Exchange), plus the same capsule summary for each item as seen in FIG. 6 inclusive of business hours, contact information, phone and direct email link. The Client can remove items as desired and manage their itinerary. When they are satisfied they can book their itinerary directly through the booking agents associated with each item (by phone, email, or website).

It is envisioned that a number of URLs will be maintained by the Manager, each one dedicated to a different geographic location and presenting a localized website directed thereto. Nevertheless, all of the various web portals have common elements and their content may be easily maintained and updated individually through the use of a suitable data management system.

It should now be apparent that the web portal of the present invention aids a potential traveler in finding localized information specific to a particular geographic area, and offers specific answers to questions that they might have, as well as a consolidated “view and print” (not booking) search engine that offers their desired arrangements for direct booking through that agent. In the context of the present system this coordinates the efforts of booking agents “Vendors”, potential traveler “Clients” and the“Manager”, and provides more value at a considerable savings of time and effort.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. A website portal for potential travelers to find localized information specific to a particular geographic area and compile an itinerary, comprising:
a web-enabled server maintained by a Manager and hosting a database comprising information on a plurality of tourist attractions, businesses, lodging establishments, and restaurants all within a defined geographical area;
a website maintained on web-enabled server to facilitate interaction and provide information to potential traveler Clients, said website comprising,
a home page containing introductory travel information on the geographic area and URL links to a collection of pages including,
a Tourism page comprising a search function for allowing the Clients to specify desired tourist attractions and resources in which they are interested,
a Business page comprising a search function for allowing the Clients to specify desired businesses and resources in which they are interested,
a Lodging page comprising a search function for allowing the Clients to specify desired lodging characteristics in which they are interested, and
a Restaurant page comprising a search function for allowing the Clients to specify desired restaurants in which they are interested,
all of said Tourism, Business, Lodging and Restaurant pages including a link to initiate compiling of the Client specified characteristics of interest into a query and to send said query to a search engine for searching said database and to compile search results from said plurality of predefined tourist attractions, businesses, lodging establishments, and restaurants sorted by best match; and
an itinerary for allowing said Clients to select from said search results and compile their personal itinerary for consolidated display with contact information for direct booking.

2. The website portal for potential travelers according to claim 1, wherein each of said Tourism page, Business page, Lodging page and Restaurant page comprises an alternate search function including a standard keyword search form and a specific search form for allowing the Clients to specify a particular city and a region.

3. The website portal for potential travelers according to claim 2, wherein the specific search form for said Tourism page allows the Clients to specify a particular type of tourist attraction.

4. The website portal for potential travelers according to claim 3, wherein the specific search form for said Business page allows the Clients to specify a particular type of business.

5. The website portal for potential travelers according to claim 4, wherein the specific search form for said Lodging page allows the Clients to specify a particular type of lodging.

6. The website portal for potential travelers according to claim 5, wherein the specific search form for said Restaurant page allows the Clients to specify a particular type of restaurant.

7. The website portal for potential travelers according to claim 3, wherein the specific search forms for said Lodging and Restaurant page allows the Clients to specify a particular price range.

8. The website portal for potential travelers according to claim 2, further comprising an Upcoming Events page for displaying a list of upcoming local events in said local area.

9. The website portal for potential travelers according to claim 2, whereby said Business, Tourism, Lodging and Restaurants pages allow said Clients to search and select entries from among the search results and compile an itinerary there from.

10. The website portal for potential travelers according to claim 9, wherein items in the itinerary are tracked and displayed at will of the Clients in form of a detailed display for each itinerary item with contact information, phone and direct email link so that Clients can book their itinerary directly through booking agents associated with each item.

11. A web enabled method for potential travelers to find localized information specific to a particular geographic area and compile an itinerary, comprising the steps of:
maintaining a web server hosting a database comprising information on a plurality of tourist attractions, businesses, lodging establishments, and restaurants all within a defined geographical area;
providing a website on said web-enabled server comprising a home page containing introductory travel information on the geographic area, a Tourism page to allow Clients to specify desired tourist attractions and resources in which they are interested, a Business page for allowing the Clients to specify desired businesses and resources in which they are interested, a Lodging page for allowing the Clients to specify desired lodging characteristics in which they are interested, and a Restaurant page for allowing the Clients to specify desired restaurants in which they are interested,
providing a search engine for searching the database for specific tourist attractions, businesses, lodging establishments, and restaurants within said defined geographical area based on specified characteristics entered in said Tourism, Business, Lodging and Restaurant pages sorted by best match;
selecting individual results from among said search results; and
compiling a running itinerary of selected individual results and allowing consolidated display of said running itinerary with contact information for direct booking.

12. A website portal for finding information on specific commercial establishments within a particular geographic area and compiling a detailed report there from, comprising:
a web-enabled server maintained by a Manager and hosting a database comprising information on a plurality of commercial establishments all within a defined geographical area;
a website maintained on web-enabled server to facilitate interaction and provide information to potential Clients, said website comprising,
a home page containing introductory information on the geographic area and URL links to a collection of pages including a plurality of commercial establishments pages each devoted to a specific type of commercial establishment and each comprising a search function for allowing the Clients to select an alternate search function including a standard keyword search form and a specific search form for allowing the Clients to specify interests selected from among a group including characteristics, city, region and cost, all of said commercial establishment pages including a link to initiate compiling of the Client specified interests into a query and to send said query to a search engine for searching said database and to compile search results sorted by best match; and
means for allowing said Clients to select one or more of said search results and compile a detailed report for consolidated display of selected search results with contact information for direct contact with said commercial establishments.

13. The website portal according to claim 12, further comprising an Upcoming Events page for displaying a list of upcoming local events in said local area.

14. The website portal according to claim 12, wherein said detailed report for consolidated display of selected search results includes contact information, phone and direct email link to each selected commercial establishment so that Clients can correspond directly there with.
